(19) United States
(12) Patent Application Publication
(10) Pub. No.: US 2014/0291910 A1
(43) Pub. Date: Oct. 2, 2014

(54) ASSEMBLY JIG

(71) Applicant: FUJITSU LIMITED, Kawasaki-shi (JP)

(72) Inventor: Yuka Nishio, Kahoku (JP)

(73) Assignee: FUJITSU LIMITED, Kawasaki-shi (JP)

(21) Appl. No.: 14/160,604

(22) Filed: Jan. 22, 2014

(30) Foreign Application Priority Data
Mar. 28, 2013 (JP) 2013-070360

(51) Int. Cl. B25B 11/02

(52) U.S. Cl. CPC B25B 11/02
USPC 269/305

(57) ABSTRACT

An assembly jig, includes: a base unit; a first wall unit that is stood on the base unit; a second wall unit that is arranged in parallel with the first wall unit, and forms a member holding unit between the first wall unit and the second wall unit; and at least two contact surfaces that contact a work table.

### CROSS-REFERENCE TO RELATED APPLICATION

This application is based upon and claims the benefit of priority of the prior Japanese Patent Application No. 2013-070360 filed on Mar. 28, 2013, the entire contents of which are incorporated herein by reference.

### FIELD

A certain aspect of the embodiments is related to an assembly jig.

### BACKGROUND

When other parts are attached and assembled to the component which makes a basic frame, the assembly work from many directions of the component may be required. When a manual assembly is required, a worker may have to perform assembly work while holding a plurality of components and parts simultaneously according to the kinds of components or parts. It is considered that, in response to the request, the component which makes the frame is set and held to the jig and the assembly work is performed. Patent Document 1 (i.e., Japanese Laid-open Patent Publication No. 2001-13873) discloses a case stand that can hold a card as an article, for example.

### SUMMARY

According to an aspect of the present invention, there is provided an assembly jig, including: a base unit; a first wall unit that is stood on the base unit; a second wall unit that is arranged in parallel with the first wall unit, and forms a member holding unit between the first wall unit and the second wall unit; and at least two contact surfaces that contact a work table.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a perspective view of an assembly jig according to an embodiment, as viewed from a front surface;

FIG. 1B is a perspective view of the assembly jig according to the embodiment, as viewed from a rear surface;

FIG. 2A is a front view of the assembly jig according to the embodiment;

FIG. 2B is a top view of the assembly jig according to the embodiment;

FIG. 2C is a bottom view of the assembly jig according to the embodiment;

FIG. 2D is a right side view of the assembly jig according to the embodiment;

FIG. 2E is a left side view of the assembly jig according to the embodiment;

FIG. 2F is a rear view of the assembly jig according to the embodiment;

FIG. 3 is an exploded perspective view of the assembly jig according to the embodiment;

FIG. 4 is an exploded perspective view of a PC card cassette assembled using the assembly jig according to the embodiment;

FIG. 5 is an explanation view illustrating an expanded front end portion of a substrate mounted on a cassette body;

FIG. 6 is a perspective view of the PC card cassette assembled using the assembly jig according to the embodiment;

FIG. 7A is a perspective view of a base unit included in the assembly jig according to the embodiment, as viewed from a top surface;

FIG. 7B is a perspective view of the base unit included in the assembly jig according to the embodiment, as viewed from a bottom surface;

FIG. 8A is a front view of the base unit included in the assembly jig according to the embodiment;

FIG. 8B is a top view of the base unit included in the assembly jig according to the embodiment;

FIG. 8C is a bottom view of the base unit included in the assembly jig according to the embodiment;

FIG. 8D is a right side view of the base unit included in the assembly jig according to the embodiment;

FIG. 8E is a left side view of the base unit included in the assembly jig according to the embodiment;

FIG. 8F is a rear view of the base unit included in the assembly jig according to the embodiment;

FIG. 9A is a perspective view of a first wall unit included in the assembly jig according to the embodiment, as viewed from a front surface (i.e., as viewed from a surface opposed to a second wall unit);

FIG. 9B is a perspective view of the first wall unit included in the assembly jig according to the embodiment, as viewed from a rear surface;

FIG. 10A is a front view of the first wall unit included in the assembly jig according to the embodiment;

FIG. 10B is a top view of the first wall unit included in the assembly jig according to the embodiment;

FIG. 10C is a bottom view of the first wall unit included in the assembly jig according to the embodiment;

FIG. 10D is a right side view of the first wall unit included in the assembly jig according to the embodiment;

FIG. 10E is a left side view of the first wall unit included in the assembly jig according to the embodiment;

FIG. 10F is a rear view of the first wall unit included in the assembly jig according to the embodiment;

FIG. 11A is a perspective view of the second wall unit included in the assembly jig according to the embodiment, as viewed from the front surface;

FIG. 11B is a perspective view of the second wall unit included in the assembly jig according to the embodiment, as viewed from the rear surface (i.e., as viewed from a surface opposed to the first wall unit);

FIG. 12A is a front view of the second wall unit included in the assembly jig according to the embodiment;

FIG. 12B is a top view of the second wall unit included in the assembly jig according to the embodiment;

FIG. 12C is a bottom view of the second wall unit included in the assembly jig according to the embodiment;

FIG. 12D is a right side view of the second wall unit included in the assembly jig according to the embodiment;

FIG. 12E is a left side view of the second wall unit included in the assembly jig according to the embodiment;

FIG. 12F is a rear view of the second wall unit included in the assembly jig according to the embodiment;

FIG. 13A is a perspective view of a cassette body, as viewed from the front surface;

FIG. 13B is a perspective view of the cassette body, as viewed from the rear surface;

FIG. 14A is a front view of the cassette body;

FIG. 14B is a top view of the cassette body;

FIG. 14C is a bottom view of the cassette body;

FIG. 14D is a right side view of the cassette body;

FIG. 14E is a left side view of the cassette body;

FIG. 14F is a rear view of the cassette body;

FIG. 15A is a perspective view of a side cover, as viewed from the front surface;

FIG. 15B is a perspective view of the side cover, as viewed from the rear surface;

FIG. 16 is a perspective view of a substrate, as viewed from a reverse side;

FIG. 17A is a perspective view of a bottom cover, as viewed from a bottom surface side;

FIG. 17B is a perspective view of the bottom cover, as viewed from a top surface side;

FIG. 18 is an exploded view of a retention groove;

FIG. 19A is an explanation view illustrating the size of a finger hooking concave portion;

FIG. 19B is an explanation view illustrating a state where a worker hooks the thumb in the finger hooking concave portion;

FIGS. 20A to 20C are explanation views illustrating a process in which the worker hooks a thumb in the finger hooking concave portion, and contacts a second contact surface with a work table;

FIGS. 21A to 21D are explanation views illustrating examples of a matrix referred to when the size of a finger hooking concave portion is decided;

FIG. 22 is an explanation view illustrating a guide portion;

FIGS. 23A to 23E are explanation views illustrating a part of an assembly sequence of the PC card cassette;

FIGS. 24F to 24J are explanation views illustrating a part of the assembly sequence of the PC card cassette;

FIGS. 25K to 25N are explanation views illustrating a part of the assembly sequence of the PC card cassette;

FIG. 26 is an explanation view illustrating a state where the substrate is made to slide on the guide portion and is mounted on the cassette body;

FIG. 27 is an explanation view illustrating a state where a front end portion of the substrate is inserted in a lens storage portion;

FIG. 28 is an explanation view illustrating a state where the substrate is mounted on the cassette body; and

FIG. 29 is an explanation view illustrating a state where a third contact surface is contacted with the work table.

### DESCRIPTION OF EMBODIMENTS

In the case stand disclosed in the Patent Document 1 described above, the usage as the assembly jig is not assumed from the beginning, and hence the case stand cannot be adapted to various requests required by the assembly work.

A description will now be given of embodiment of the present invention with reference to attached drawings. It should be noted that a size and ratio of each element do not correspond to the actual ones in some drawings. Also, some elements which exist in fact may be omitted in some drawings for convenience of explanation.

### Embodiment

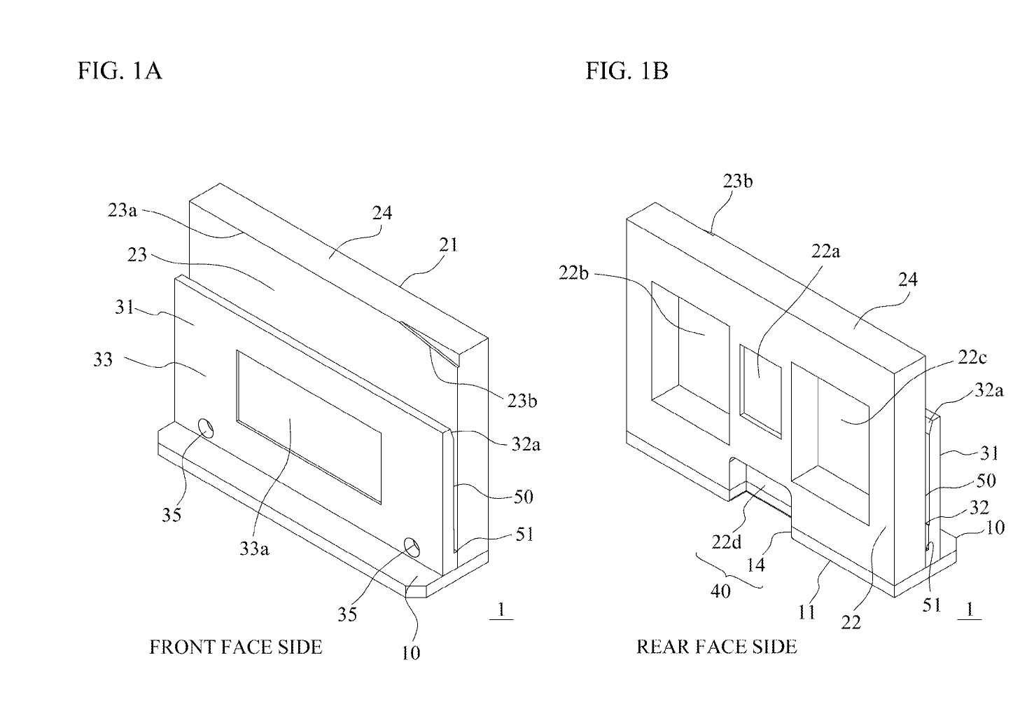

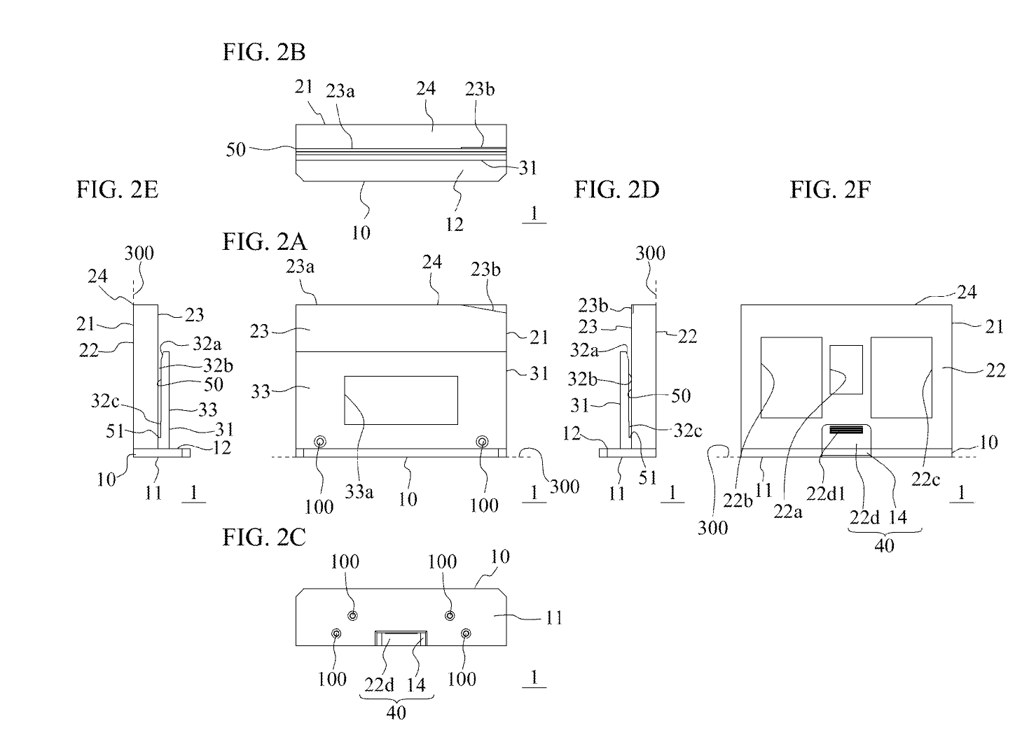

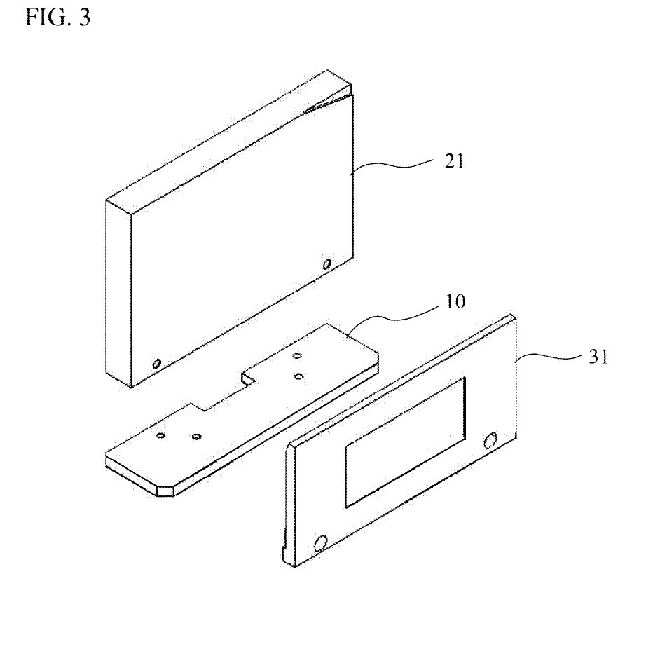

A description will be given of the schematic configuration of an assembly jig 1, with reference to FIGS. 1A to 3. FIG. 1A is a perspective view of the assembly jig 1 according to an embodiment, as viewed from a front surface. FIG. 1B is a perspective view of the assembly jig 1 according to the embodiment, as viewed from a rear surface. FIGS. 2A to 2F are six faces drawings of the assembly jig 1 according to the embodiment. FIGS. 2A to 2F illustrate a front view, a top view, a bottom view, a right side view, a left side view and a rear view of the assembly jig 1, respectively. FIG. 3 is an exploded perspective view of the assembly jig 1 according to the embodiment;

The assembly jig 1 includes a base unit 10, a first wall unit 21 and a second wall unit 31. Each of the base unit 10, the first wall unit 21 and the second wall unit 31 is a plate made of MC-nylon having conductivity. The first wall unit 21 is stood on the base unit 10 with a screw 100 which is a fastening member. The second wall unit 31 is arranged in parallel with on the opposite side of, and hence a holding groove 50 as a holding member is formed between the first wall unit 21 and the second wall unit 31. The second wall unit 31 is mounted to the first wall unit 21 with the screw 100 which is the fastening member, and the second wall unit 31 is stood on the base unit 10. Referring to FIGS. 1A to 2F, the assembly jig 1 includes at least two or more contact surfaces to a work table 300. Specifically, the base unit 10 includes a first contact surface 11 located on the opposite side of a surface on which the first wall unit 21 is stood. The first contact surface 11 appears as a bottom surface of the assembly jig 1 illustrated in FIG. 2C. The first wall unit 21 includes a second contact surface 22 located on the opposite side of a surface which is opposite to the second wall unit 31. The second contact surface 22 appears as a bottom surface of the assembly jig 1 illustrated in FIG. 2F. The first wall unit 21 includes a third contact surface 24 located on the opposite side of a surface at which the base unit 10 is located. The third contact surface 24 appears as an upper surface of the assembly jig 1 illustrated in FIG. 2B. In the present embodiment, in order to treat an electrical product as explained below, MC-nylon having conductivity is used as a material of the assembly jig 1. However, other material may be used as the material of the assembly jig 1 according to an object of an assembly.

The assembly jig 1 according to the present embodiment can be divided into three parts, and the assembly jig 1 may be integrally formed by digging the whole jig. The assembly jig 1 can be a divisible state arbitrarily. For example, the base unit 10 and the first wall unit 21 may be formed integrally, and the second wall unit 31 may be mounted thereon. In the present embodiment, the second wall unit 31 is mounted on the first wall unit 21, but the first wall unit 21 and the second wall unit 31 may be formed integrally. In the present embodiment, the second wall unit 31 is mounted on the first wall unit 21 with screws, and therefore interval adjustment of the holding groove 50 formed between the first wall unit 21 and the second wall unit 31 can be performed. Furthermore, the base unit 10 does not need to be strictly distinguished from the first wall unit 21 or the second wall unit 31, and a portion in which the above-mentioned first contact surface 11 is formed can be made into the base unit 10.

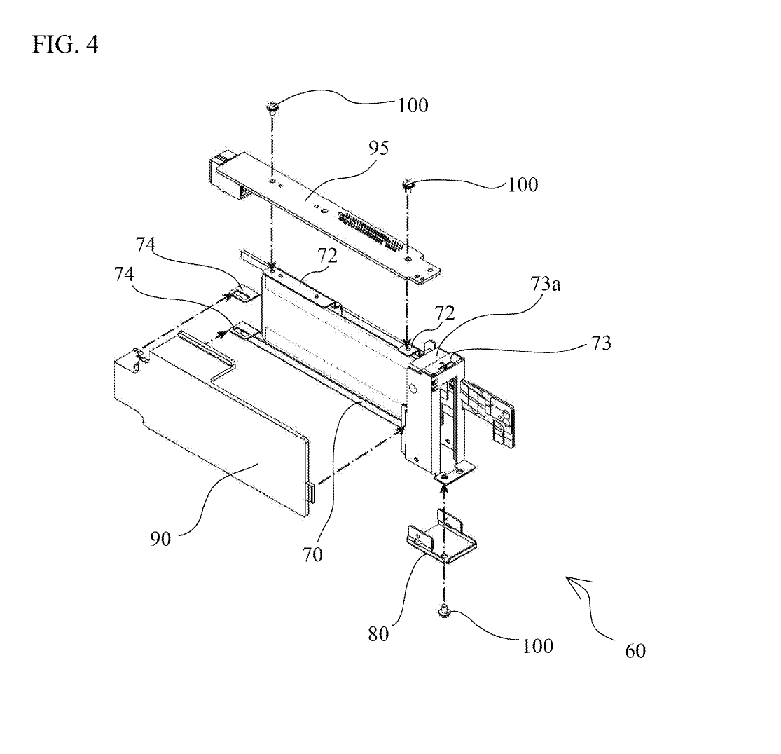

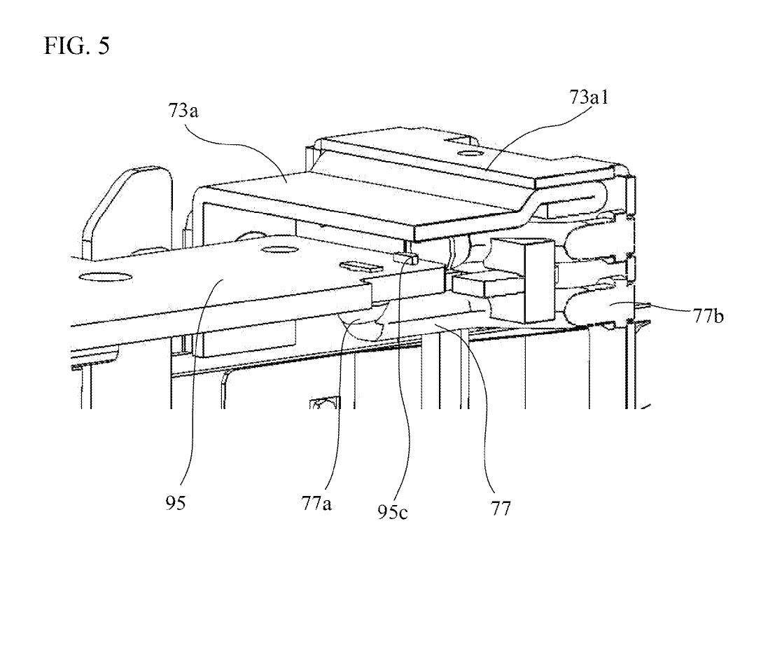

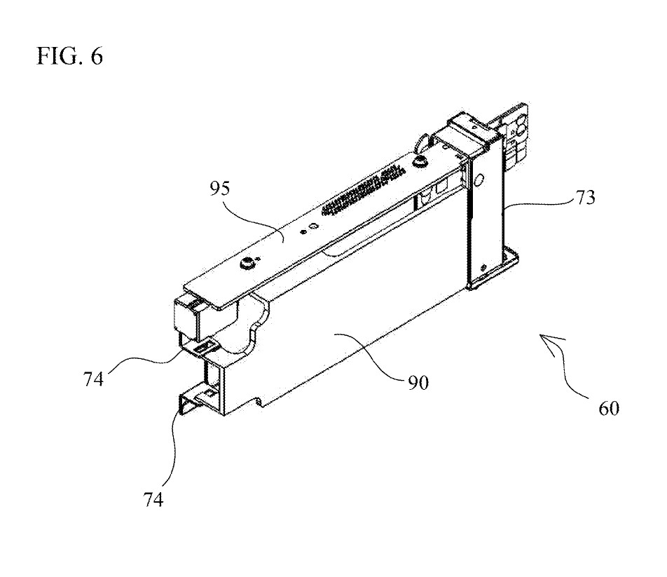

Before each portion of the assembly jig 1 is explained in detail, an article assembled by using the assembly jig 1 is explained with reference to FIGS. 4 to 6. A PC card cassette 60 is assembled by using the assembly jig 1 according to the present embodiment. The PC card cassette 60 is basically assembled by a worker's manual labor. FIG. 4 is an exploded perspective view of the PC card cassette 60 assembled using the assembly jig 1 according to the embodiment. FIG. 5 is an explanation view illustrating an expanded front end portion of a substrate 95 mounted on a cassette body 70. FIG. 6 is a perspective view of the PC card cassette 60 assembled using the assembly jig 1 according to the embodiment.

In a state where the PC card cassette 60 holds a PC card internally, the PC card cassette 60 is removed from and inserted into a housing of an electronic device, such as a server. The PC card cassette 60 is an example, and the assembly jig 1 also can be applied to the assembly of other structures.

The PC card cassette 60 includes a bottom cover 80, a side cover 90 and a substrate 95 which are mounted on the frame-like cassette body 70. The cassette body 70 includes a substrate mounting unit 72, and the substrate mounting unit 72 is mounted on the substrate 95. At this time, the front end portion of the substrate 95 is inserted into a lens storage unit 73 provided in the cassette body 70, as illustrated in FIG. 5. A lens 77 is provided in the lens storage unit 73. The lens 77 includes an incidence portion 77a and a lighting portion 77b. The substrate 95 is mounted on the cassette body 70 so that a position of a sensing element 95c provided on the front end portion of the substrate 95 is identical with a position of the incidence portion 77a of the lens 77. At this time, the worker has to take notice that the sensing element 95c does not damage a top plate portion 73a of the lens storage unit 73 and the lens 77 by contacting them.

As is clear from FIG. 4, the mounting directions of the bottom cover 80, the side cover 90 and the substrate 95 to the cassette body 70 are different from each other. That is, the mounting work from two or more directions is included in the assembly work. When the worker performs the assembly work, it is usually desirable to perform the assembly work to an object, viewing from above. This is because it is hard for the worker to view parts when the work is performed from the side, and it is hard to do work in respect of maintenance of the parts to be mounted. The assembly jig 1 responds to the requests of the worker. Specifically, the assembly jig 1 facilitates selecting the cassette body 70 as a member to be held in the holding groove 50, variously changing a direction of the cassette body 70 held in the holding groove 50, and mounting parts, such as the bottom cover 80, the side cover 90 and the substrate 95. At the time of the assembly work of each of parts, the first contact surface 11, the second contact surface 22 and the third contact surface 24 included in the assembly jig 1 can come in contact with the work table 300 one by one. Thereby, the work while the worker is viewing parts from above is permitted.

Hereinafter, a detailed description will be given of the assembly jig 1 and the PC card cassette 60.

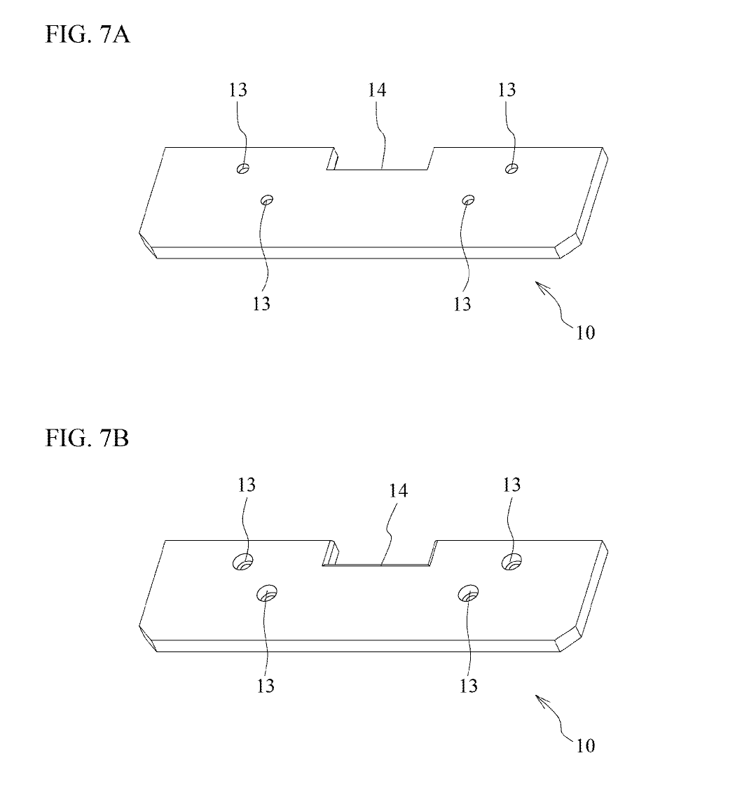

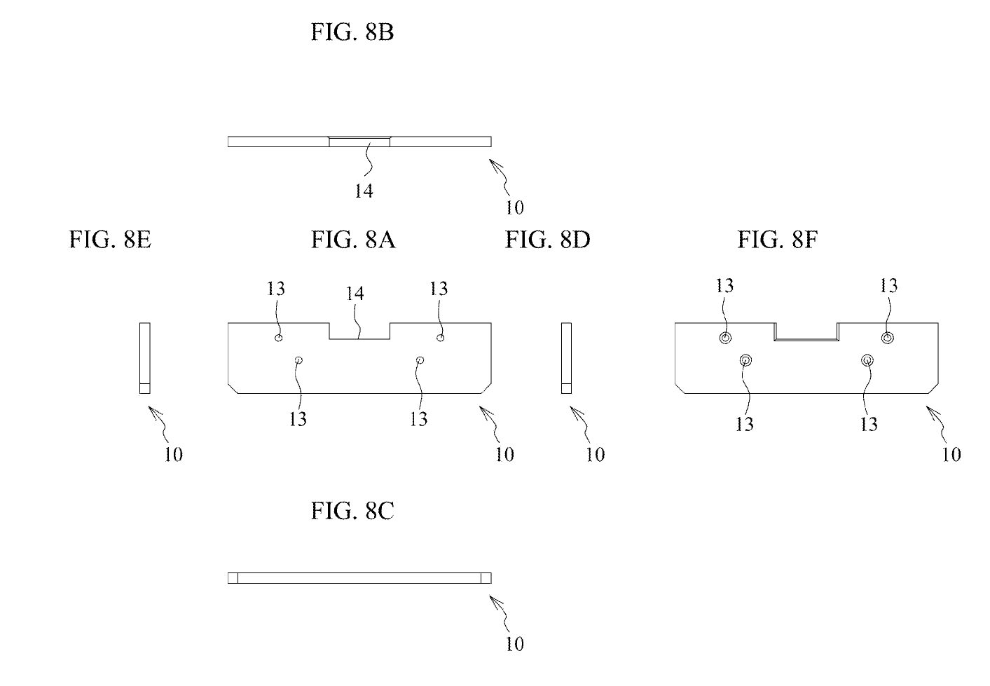

The base unit 10 is explained with reference to FIGS. 7A, 7B and 8A to 8F. FIG. 7A is a perspective view of the base unit 10 included in the assembly jig 1 according to the embodiment, as viewed from the top surface. FIG. 7B is a perspective view of the base unit 10 included in the assembly jig 1 according to the embodiment, as viewed from the bottom surface. FIGS. 8A to 8F are six faces drawings of the base unit 10 included in the assembly jig 1 according to the embodiment. FIG. 8A is a front view of the base unit 10, FIG. 8B is a top view of the base unit 10, FIG. 8C is a bottom view of the base unit 10, FIG. 8D is a right side view of the base unit 10, FIG. 8E is a left side view of the base unit 10, FIG. 8F is a rear view of the base unit 10 included in the assembly jig according to the embodiment. The base unit 10 is composed of a tabular member. The base unit 10 is a portion used as a stand when the assembly jig 1 is stood, and includes the first contact surface 11. The base unit 10 has a size in which the assembly jig 1 does not fall down in a state where the cassette body 70 is held in the holding groove 50. Thereby, in a state where the first wall unit 21 and the second wall unit 31 are mounted on the base unit 10, a projection portion 12 that projects in the front side compared with the second wall unit 31 is formed.

The base unit 10 includes screw holes 13 to mount the first wall unit 21. The base unit 10 further includes a notch portion 14. The notch portion 14 is a part of a finger hooking concave portion 40 as explained hereinafter.

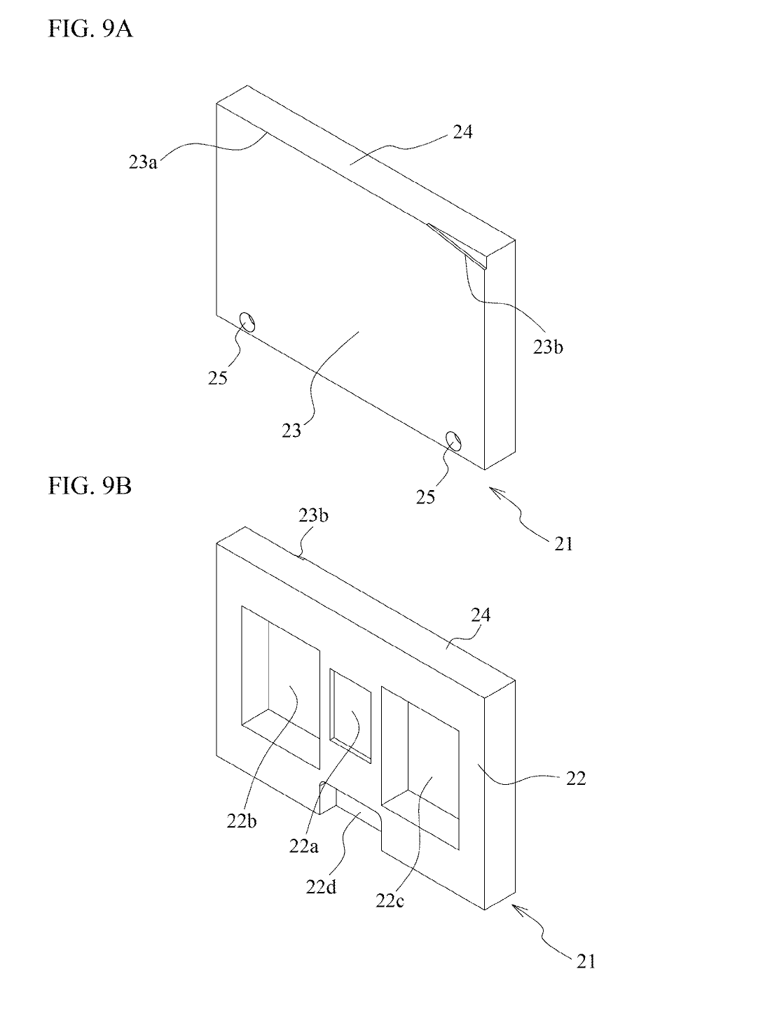

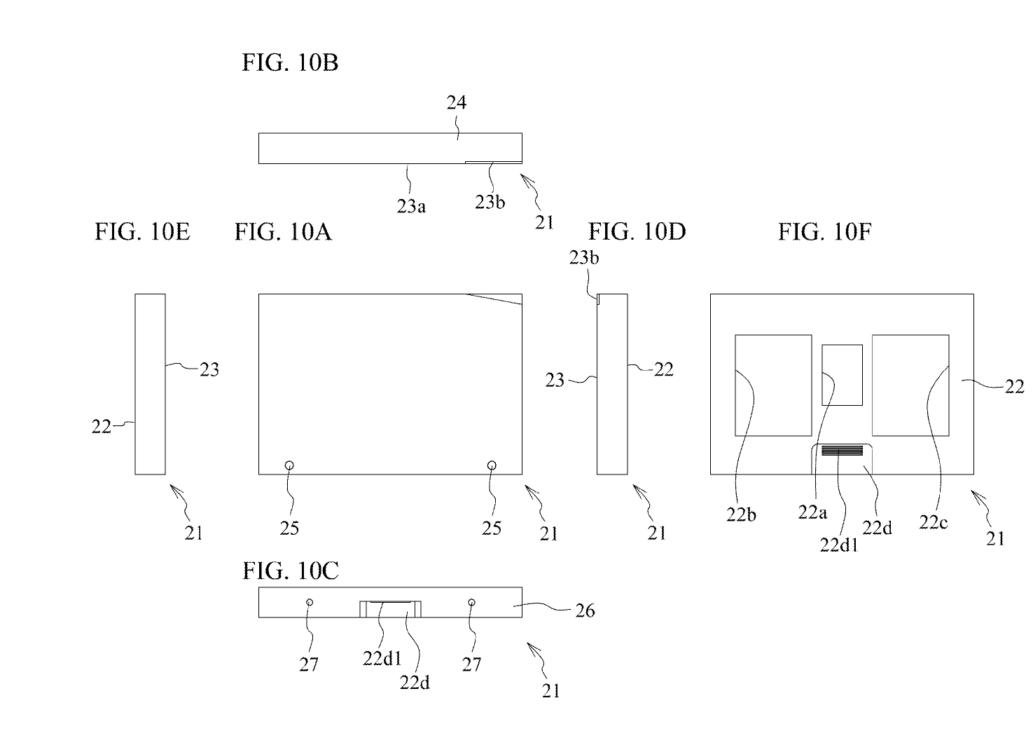

The first wall unit 21 is explained with reference to FIGS. 9A, 9B and 10A to 10F. FIG. 9A is a perspective view of the first wall unit 21 included in the assembly jig 1 according to the embodiment, as viewed from a front surface, i.e., as viewed from a surface opposed to a second wall unit 31. FIG. 9B is a perspective view of the first wall unit 21 included in the assembly jig 1 according to the embodiment, as viewed from a rear surface. FIGS. 10A to 10F are six faces drawings of the first wall unit 21 included in the assembly jig 1 according to the embodiment. FIG. 10A is a front view of the first wall unit 21, FIG. 10B is a top view of the first wall unit 21, FIG. 10C is a bottom view of the first wall unit 21, FIG. 10D is a right side view of the first wall unit 21, FIG. 10E is a left side view of the first wall unit 21, and FIG. 10F is a rear view of the first wall unit 21.

The base unit 10 is a tabular member. A surface located in the rear side of the first wall unit 21 becomes the second contact surface 22. The second contact surface 22 becomes an external wall surface, and includes a first concave portion 22a at the center thereof. The first concave portion 22a corresponds to a nonslip portion. Here, as the nonslip portion, a conventionally well-known nonslip means, such as pasting a nonslip sheet, can be adopted, for example. The second contact surface 22 includes a second concave portion 22b and a third concave portion 22c in the both sides of the first concave portion 22a. The second concave portion 22b and the third concave portion 22c are deeper than the first concave portion 22a. Thus, the second concave portion 22b and the third concave portion 22c are formed, so that the weight of the first wall unit 21 can be reduced. The second concave portion 22b and the third concave portion 22c can also be used as a pinch unit when the assembly jig 1 is lifted or held.

The first wall unit 21 includes an opening concave portion 22d below the first concave portion 22a. The opening concave portion 22d forms the finger hooking concave portion 40 by being united with the notch portion 14 provided in the base unit 10. The finger hooking concave portion 40 is formed on the first contact surface 11 and the second contact surface 22 adjacent to the first contact surface 11. When the second contact surface 22 is in contact with the work table, a worker can insert his thumb 201 into the finger hooking concave portion 40. By inserting the thumb 201 in the finger hooking concave portion 40, the worker can lift the assembly jig 1 so as to dip up it. Here, a nonslip portion 22d1 on which some fine grooves are incised is provided in the depth side of the opening concave portion 22d.

The first wall unit 21 includes an opposite surface 23 opposed to the second wall unit 31 when constituting the assembly jig 1. The opposite surface 23 is located in the back side of the second contact surface 22 in the first wall unit 21. When the substrate mounting unit 72 is mounted on the substrate 95, a guide portion 23b guiding the substrate 95 is provided on an upper edge 23a of the opposite surface 23. The guide portion 23b guides a part, i.e., the substrate 95 to be assembled to the cassette body 70 which is held in the holding groove 50, to the assembly position of the cassette body 70. Specifically, the guide portion 23b is an incline plane which can supply the substrate 95 aslant to the cassette body 70. The opposite surface 23 includes screw holes 25 for mounting the second wall unit 31.

The first wall unit 21 includes the third contact surface 24 located on the opposite side of a surface at which the base unit 10 is located. That is, a surface sandwiched between the second contact surface 22 and the opposite surface 23 is the third contact surface 24. The position of the third contact surface 24 in the height direction is set so that the substrate 95 mounted on the cassette body 70 does not come in contact with the work table 300 at the time of assembly work.

With reference to FIG. 10C, the first wall unit 21 includes a contact surface 26 coming in contact with the base unit 10. Screw holes 27 for mounting the first wall unit 21 on the base unit 10 are provided on the contact surface 26. The contact surface 26 is located on the opposite side of the third contact surface 24. Thus, the third contact surface 24 is located on the opposite side of a side in which the base unit 10 is located.

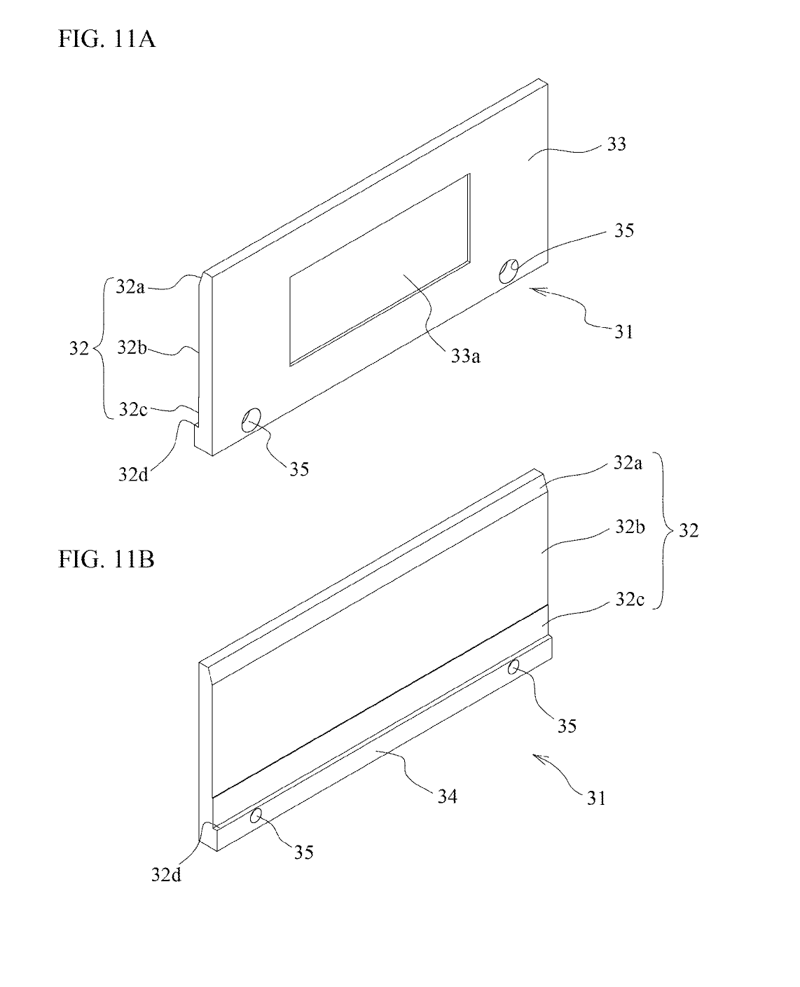

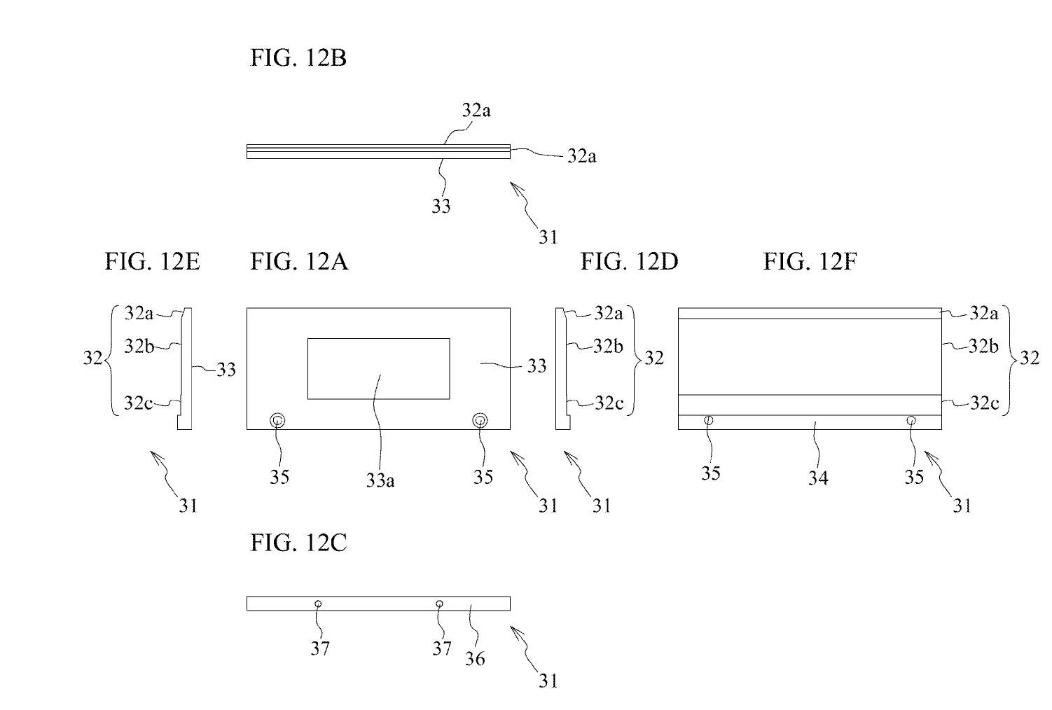

Next, the second wall unit 31 is explained with reference to FIGS. 11A, 11B, and 12A to 12F. FIG. 11A is a perspective view of the second wall unit 31 included in the assembly jig 1 according to the embodiment, as viewed from the front surface. FIG. 11B is a perspective view of the second wall unit 31 included in the assembly jig 1 according to the embodiment, as viewed from the rear surface, i.e., as viewed from a surface opposed to the first wall unit 21. FIGS. 12A to 12F are six faces drawings of the second wall unit 31 included in the assembly jig 1 according to the embodiment. FIG. 12A is a front view of the second wall unit 31, FIG. 12B is a top view of the second wall unit 31, FIG. 12C is a bottom view of the second wall unit 31, FIG. 12D is a right side view of the second wall unit 31, FIG. 12E is a left side view of the second wall unit 31, and FIG. 12F is a rear view of the second wall unit 31.

The second wall unit 31 has a low height as compared with the first wall unit 21. This is because of avoiding the second wall unit 31 from interfering with the cassette body 70 held in the holding groove 50. The second wall unit 31 includes an opposite surface 32 opposed to the first wall unit 21. The first wall unit 21 and the second wall unit 31 are opposed to each other and are arranged in parallel, and hence the opposite surface 32 forms the holding groove 50 along with the opposite surface 23 of the first wall unit 21. The bottom portion of the opposite surface 32 includes a step portion 32d forming a bottom portion 51 of the holding groove 50. Thus, the opposite surface 32 has a shape so that the width of the holding groove 50 becomes narrow toward the bottom portion 51. Specifically, the second wall unit 31 includes: a taper portion 32a that is located on an upper edge of the opposite surface 32; a middle portion 32b that is located below the taper portion 32a; and a step portion 32c that is provided near a bottom portion of the second wall unit 31 and protrudes to the inside of the holding groove 50. Thus, the width of the holding groove 50 becomes narrow toward the bottom portion 51, so that the cassette body 70 which is a holding object can be held steadily and can be taken out easily. In the present embodiment, the cassette body 70 which is a holding object is held by changing the width of the holding groove 50 gradually. However, the cassette body 70 may be held by equipping the holding groove 50 with another means e.g. a blade spring or the like.

The second wall unit 31 includes a concave portion 33a on a surface which is a reverse side of the opposite surface 32, i.e., on a front surface 33 illustrated in FIG. 11A. The concave portion 33a corresponds to a nonslip portion. Here, as the nonslip portion, a conventionally well-known nonslip means, such as pasting a nonslip sheet, can be adopted, for example.

The second wall unit 31 includes screw holes 35 for mounting the second wall unit 31 on the first wall unit 21. Moreover, with reference to FIG. 12C, the second wall unit 31 includes a contact surface 36 coming in contact with the base unit 10. Screw holes 37 for mounting the second wall unit 31 on the base unit 10 are provided on the contact surface 36.

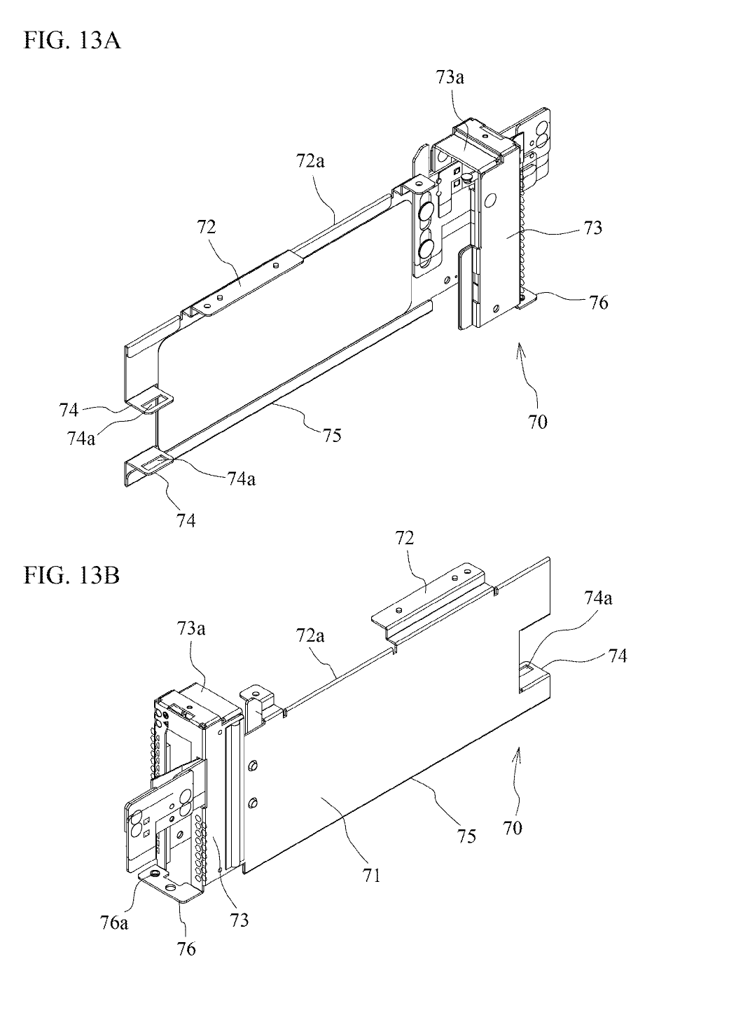

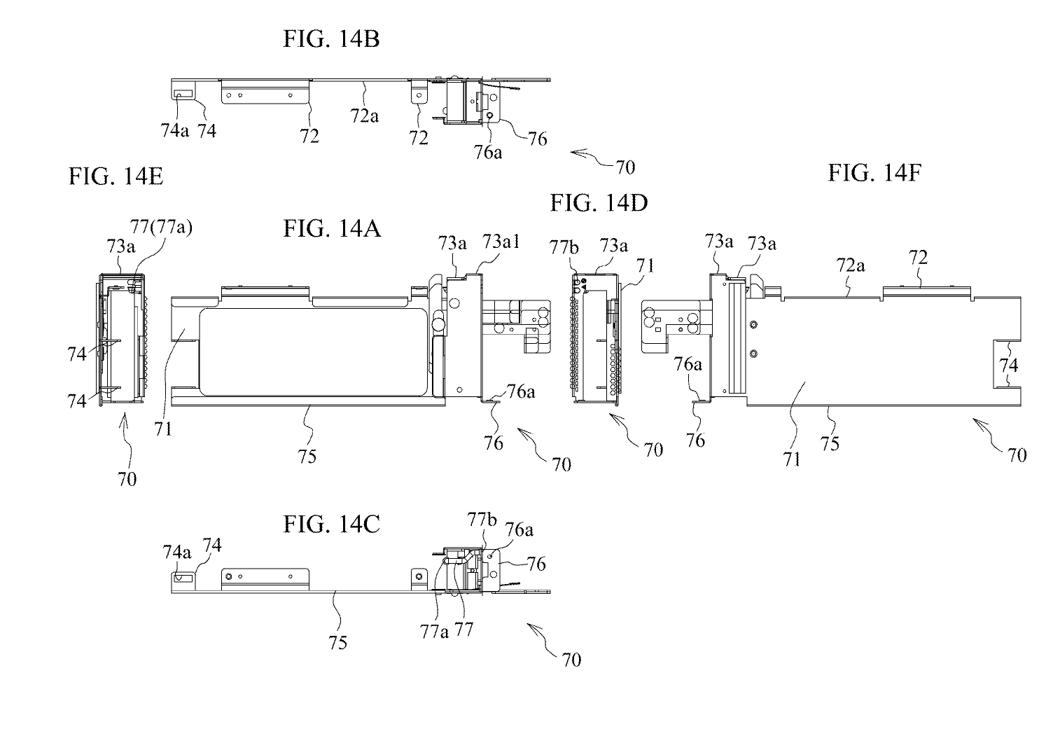

Next, the cassette body 70 is explained with reference to FIGS. 13A, 13B and 14A to 14F. FIG. 13A is a perspective view of the cassette body 70, as viewed from the front surface. FIG. 13B is a perspective view of the cassette body 70, as viewed from the rear surface. FIGS. 14A to 14F are six faces drawings of the cassette body 70. FIG. 14A is a front view of the cassette body, FIG. 14B is a top view of the cassette body, FIG. 14C is a bottom view of the cassette body, FIG. 14D is a right side view of the cassette body, FIG. 14E is a left side view of the cassette body, and FIG. 14F is a rear view of the cassette body.

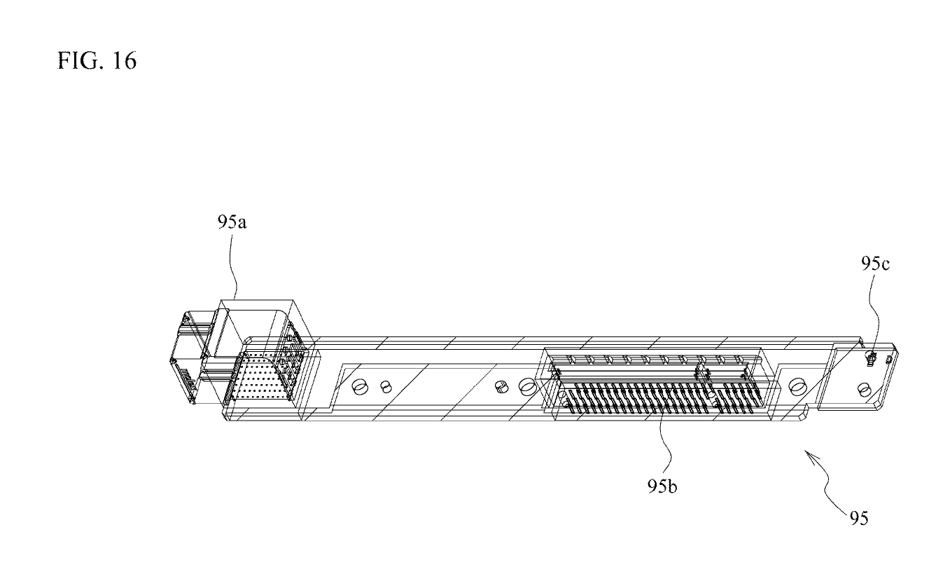

The cassette body 70 is a frame-like member. The cassette body 70 includes a side plate unit 71. The substrate mounting unit 72 is formed on an upper edge of the side plate unit 71. The substrate mounting unit 72 includes a notch portion 72a. The notch portion 72a is formed in order to avoid interference with the substrate 95, i.e., interference with a card connector unit 95b (see FIG. 16) included in the substrate 95. The cassette body 70 includes the box-like lens storage unit 73 at one end thereof. When the assembled PC card cassette 60 is installed in the housing of the electronic device, the lens storage unit 73 is located on the outside of the housing of the electronic device. The lens storage unit 73 includes the top plate portion 73a. The top plate portion 73a has a step, and the highest position of the step is made into a top face 73a1. When the cassette body 70 is mounted on the assembly jig 1, the top face 73a1 becomes flush with the third contact surface 24.

The cassette body 70 has an engaging unit 74 that includes an engaging hole 74a at another end different from the one end where the lens storage unit 73 is provided. The engaging unit 74 is used for the attachment of the side cover 90.

A lower end portion 75 of the cassette body 70 is formed by folding back a lower end of the side plate unit 71. When the cassette body 70 is mounted on the assembly jig 1, the lower end portion 75 is located on the bottom portion 51 of the holding groove 50. That is, the lower end portion 75 is sandwiched between the opposite surface 23 and the step portion 32c, and hence the cassette body 70 is held in the holding groove 50. By the folding processing of the lower end portion 75, the intensity of the cassette body 70 can be improved, but the folding processing is not necessarily required. When the folding processing is not performed, the lower end portion 75 becomes thin. In this case, by adjusting the size of the holding groove 50, it is possible to treat the thinness of the lower end portion 75.

In the cassette body 70, a collar-shaped mounting stay 76 for mounting the bottom cover 80 is provided below the lens storage unit 73. Screw holes 76a are provided on the mounting stay 76.

As illustrated in FIG. 14C, the cassette body 70 stores the lens 77 into the lens storage unit 73. The lens 77 includes the incidence portion 77a and the lighting portion 77b. The incidence portion 77a is located on the inside of the lens storage unit 73, and the lighting portion 77b is arranged so as to expose to the outside of the lens storage unit 73. When the PC card cassette 60 is mounted on the housing of the electronic device, the lighting portion 77b is in a state where a lighting state can be checked from the exterior of the housing.

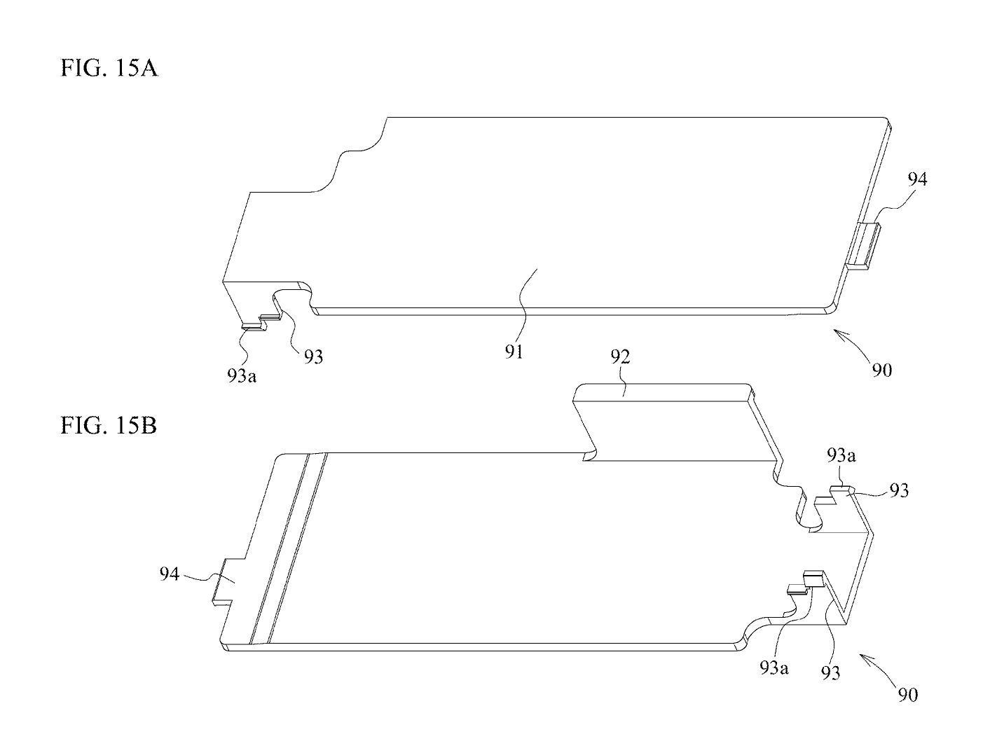

Next, the side cover 90 is explained with reference to FIGS. 15A and 15B. FIG. 15A is a perspective view of the side cover 90, as viewed from the front surface. FIG. 15B is a perspective view of the side cover 90, as viewed from the rear surface.

The side cover 90 includes a side plate unit 91. A collar-shaped portion 92 located below the substrate 95 at the time of the assembly is provided on the side plate unit 91. Two claw-shaped portions 93 are provided on the side plate unit 91. Each of the claw-shaped portions 93 includes a hook-shaped portion 93a at a front edge thereof. At the time of the assembly, each hook-shaped portion 93a engages with the engaging hole 74a which the cassette body 70 includes. The side plate unit 91 includes an insertion portion 94 at one end different from another end on which the claw-shaped portions 93 are provided. At the time of the assembly, the insertion portion 94 is inserted into the lens storage unit 73 which the cassette body 70 includes.

Next, the substrate 95 is explained with reference to FIG. 16. FIG. 16 is a perspective view of the substrate 95, as viewed from a reverse side. The substrate 95 includes a connector 95a at a rear end portion thereof. The substrate 95 includes a card connector unit 95b. A PC card is inserted into and extracted from the card connector unit 95b. The substrate 95 includes a sensing element 95c at a front end portion thereof. As described above, the sensing element 95c is arranged so as to be identical with the position of the incidence portion 77a of the lens 77 at the time of the assembly.

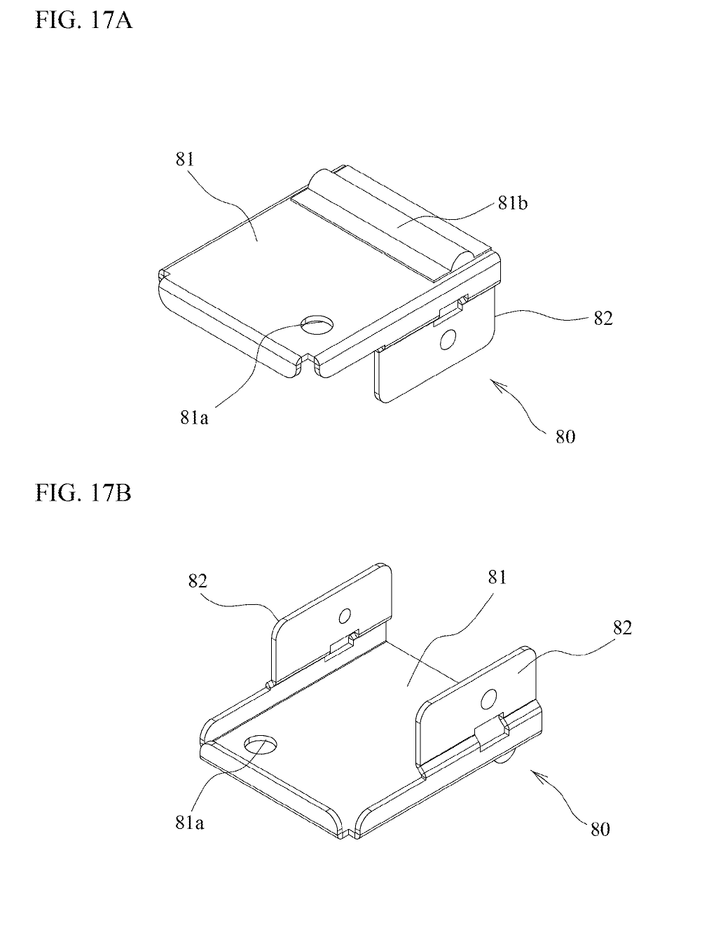

Next, the bottom cover 80 is explained with reference to FIGS. 17A and 17B. FIG. 17A is a perspective view of the bottom cover 80, as viewed from a bottom surface side. FIG. 17B is a perspective view of the bottom cover 80, as viewed from a top surface side. The bottom cover 80 includes a bottom plate portion 81. The bottom plate portion 81 includes a screw hole 81a. A sliding portion 81b is provided on the bottom plate portion 81. When the PC card cassette 60 is mounted on the housing of the electronic device, the sliding portion 81b slides in a state of coming in contact with a guide rail portion which the housing includes, and makes extraction and insertion of the PC card cassette 60 easy. The bottom cover 80 includes insertion portions 82 provided on both sides of the bottom plate portion 81. Each of the insertion portions 82 is a tabular portion to be inserted into the lower end portion of the lens storage unit 73.

As described above, a plurality of parts constituting the PC card cassette 60 to be assembled with the assembly jig 1 is mounted on the cassette body 70 from the different directions. Here, the details of the assembly jig 1 which can easily perform the work from a plurality of directions included in the assembly work are further explained.

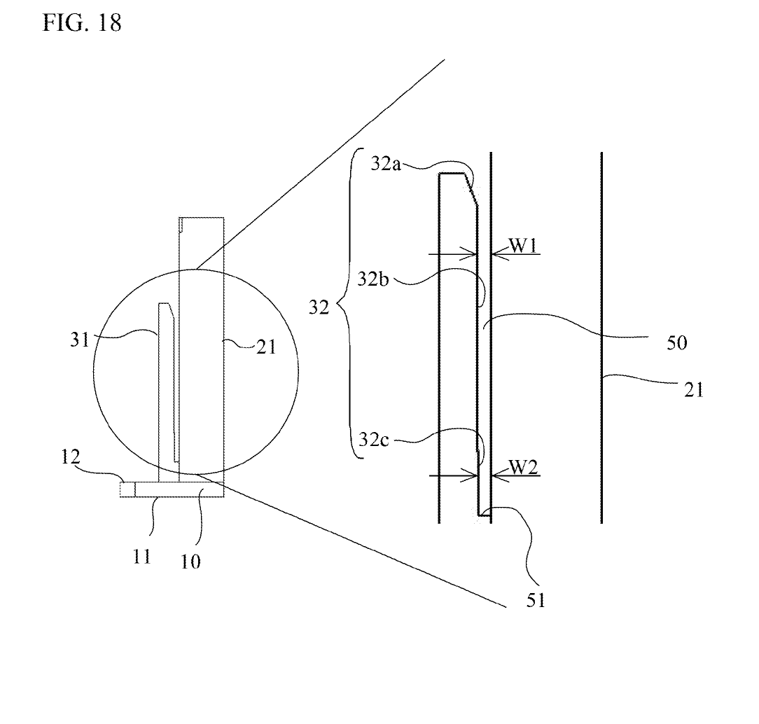

First, referring to FIG. 18, with respect to a width of the holding groove 50 formed by arranging the first wall unit 21 in opposition to the second wall unit 31, a lower width, i.e., a width W2 near the bottom portion 51 becomes narrower than an upper width W1. Thus, the assembly jig 1 has a shape in which the width becomes narrow gradually, i.e., has a wedge shape as a whole. Therefore, the lower end portion 75 of the cassette body can be smoothly introduced in the holding groove 50, and finally the cassette body 70 can be certainly held by the holding groove 50. Particularly, since the taper portion 32a is provided on the upper edge of the second wall unit 31, it becomes easy to introduce the cassette body 70 into the holding groove 50.

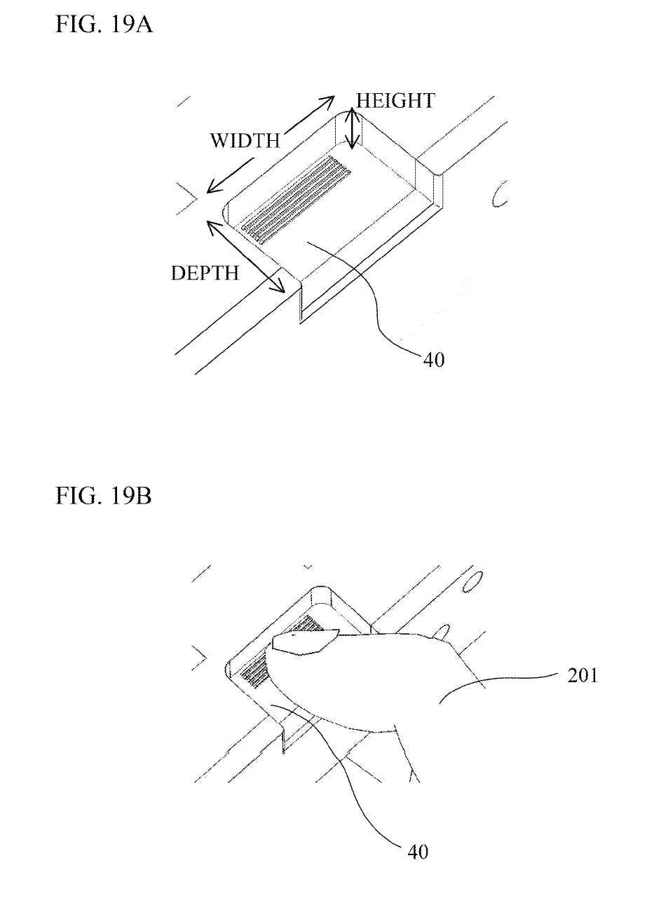

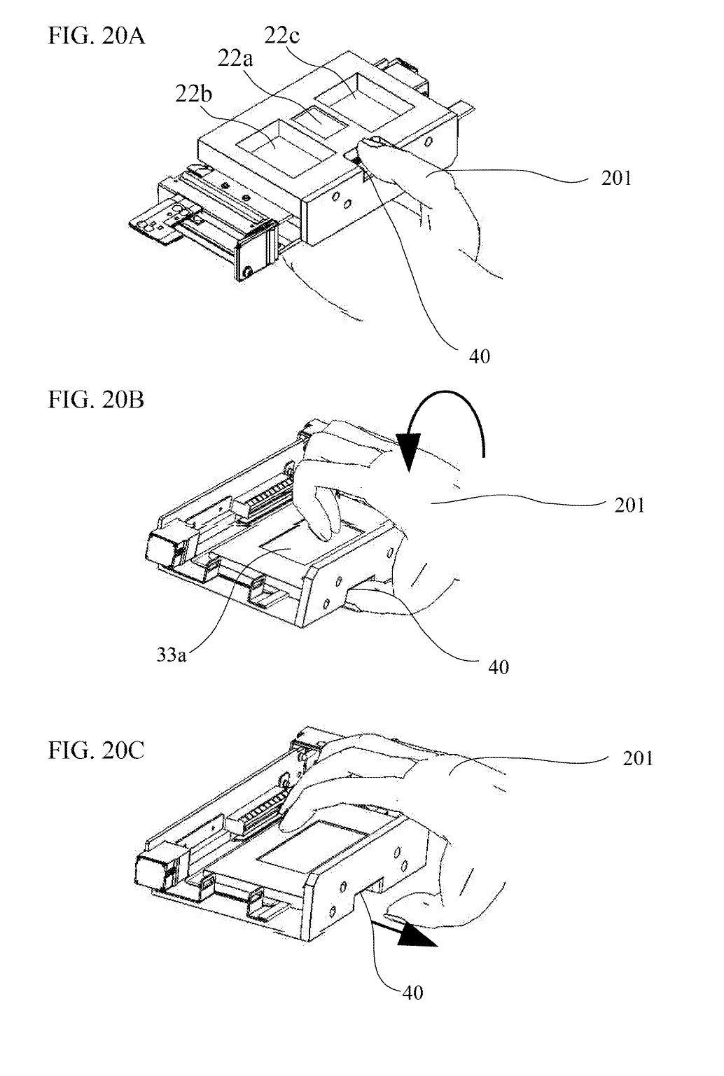

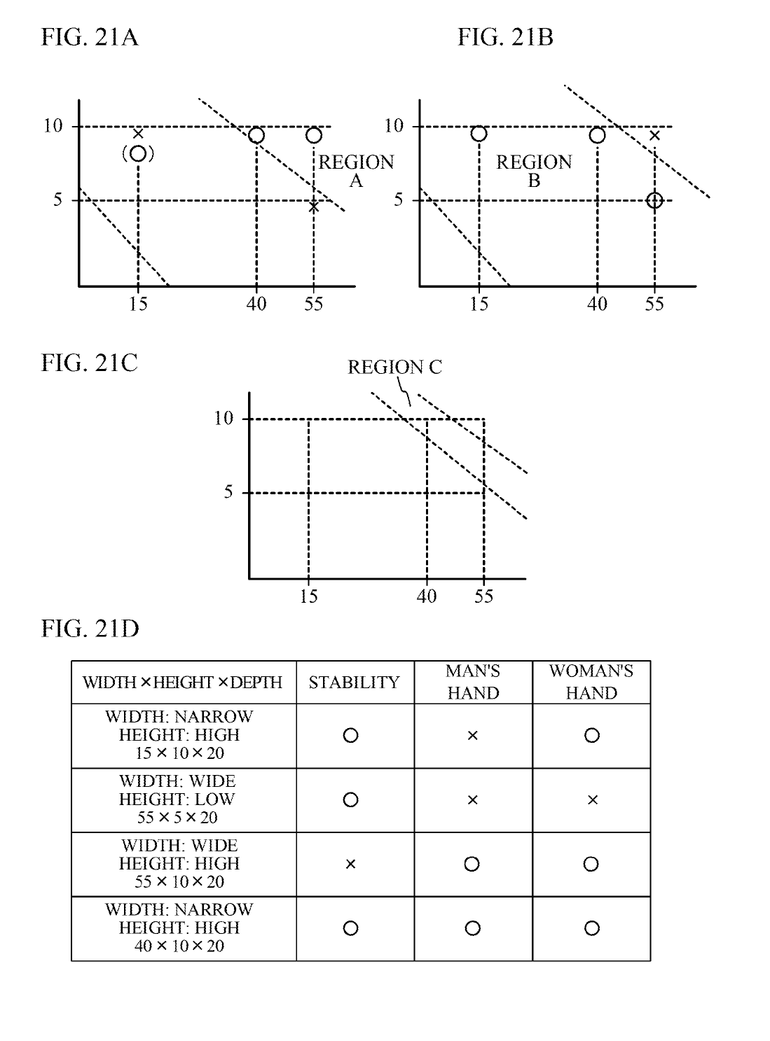

FIG. 19A is an explanation view illustrating the size of the finger hooking concave portion 40. FIG. 19B is an explanation view illustrating a state where a worker hooks the thumb in the finger hooking concave portion 40. FIGS. 20A to 20C are explanation views illustrating a process in which the worker hooks a thumb 201 in the finger hooking concave portion 40, and contacts the second contact surface 22 with the work table 300. Since the finger hooking concave portion 40 is provided, it becomes easy to contact the second contact surface 22 with the work table 300. In addition, contrary to this, it becomes easy to lift the assembly jig 1 from a state where the second contact surface 22 contacts the work table 300. Here, the assembly jig 1 is used by the workers. Since the body types of the workers differ from each other, the finger hooking concave portion 40 needs to be set to a size in which more workers can use the assembly jig 1 stably in a user friendly manner. Especially, the height and the width have the great influence on workability, and become important. Therefore, in consideration of the matrixes illustrated in FIGS. 21A to 21C, the width and the height of the finger hooking concave portion 40 are determined. First, with reference to FIG. 21A, a size with the highest flexibility is deduced from a relation with the size of a hand. For example, when the relationship between the width, the height and the depth is set to 15 mm, 10 mm and 20 mm, there is no problem of the size to a general woman's hand, but the size is too narrow to a general man's hand. For example, when the relationship between the width, the height and the depth is set to 55 mm, 5 mm and 20 mm, neither a man nor a woman can insert the thumb into the finger hooking concave portion 40. On the contrary, for example, when the relationship between the width, the height and the depth is set to 55 mm, 10 mm and 20 mm, it is easy for the male and the woman to use the finger hooking concave portion 40. When such verification is advanced and the relationship between the width and the height is set to a domain A in FIG. 21A, the size of the width and the height becomes a size which more workers can use.

Next, with reference to FIG. 21B, a size which has paid attention to the stability at the time of handling of the assembly jig 1 is deduced. For example, when the relationship between the width, the height and the depth is set to 55 mm, 10 mm and 20 mm like the example mentioned above, the size is unfavorable from an aspect of the stability. That is, the width is too wide, and hence the stable handling is disturbed. Thus, when the verification which has paid attention to the stability of handling of the assembly jig 1 is advanced, and the relationship between the width and the height is set to a domain B in FIG. 21B, the size of the width and the height becomes a size in which the stable work can be achieved.

When the verification from the relationship of the size of the hand and the verification from the stability of handling are judged comprehensively, it is desirable to set the size of the width and the height to a size in a domain C illustrated in FIG. 21C which is derived by overlapping the domain A and the domain B. In the present embodiment, the relationship between the width, the height and the depth is set to 40 mm, 10 mm and 20 mm in order to achieve the size included in the domain C. Here, the depth is uniformly evaluated as 20 mm.

By setting the finger hooking concave portion 40 as such a size, the worker can stably perform operation which rotates the assembly jig 1. As a result of being capable of handling the assembly jig 1 in a stable state, the shock to the assembly jig 1 can be reduced also when the second contact surface 22 contacts the work table 300. Since the nonslip portion 22d1 is provided on the depth side of the finger hooking concave portion 40, this contributes to the stable handling of the assembly jig 1.

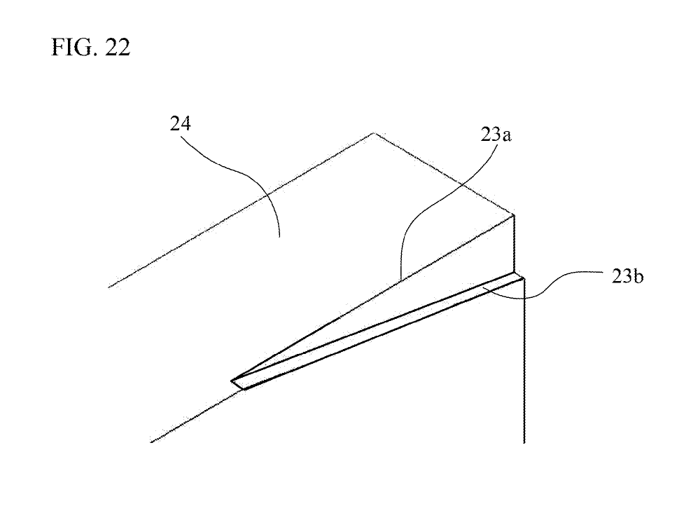

With reference to FIG. 22, the guide portion 23b that guides the substrate 95 when the substrate 95 is mounted on the substrate mounting unit 72 is provided on the upper edge 23a of the opposite surface 23. An inclination angle of the guide portion 23b is an angle in which the front end portion of the substrate 95, i.e., the portion on which the sensing element 95c is mounted is slid into the lens storage unit 73 without contacting the top plate portion 73a of the lens storage unit 73 and the incidence portion 77a of the lens 77.

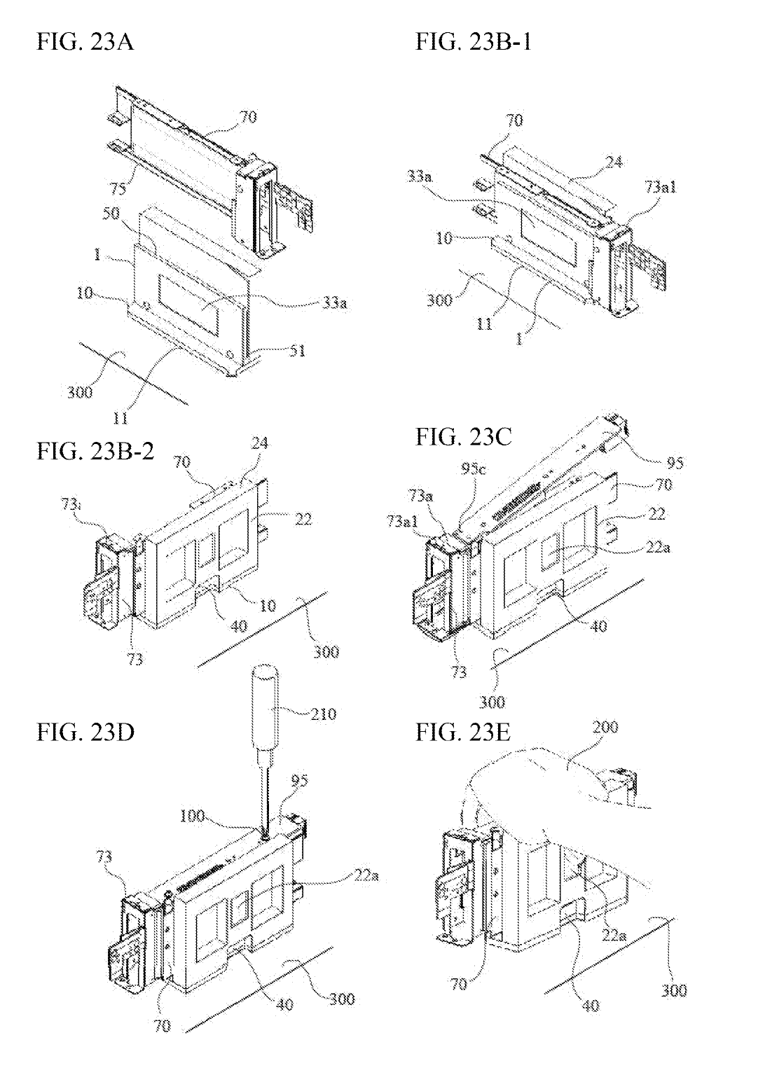

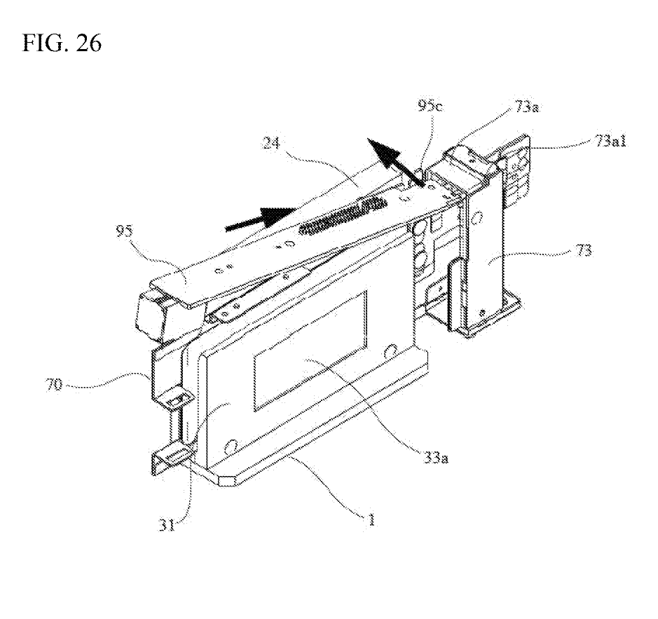

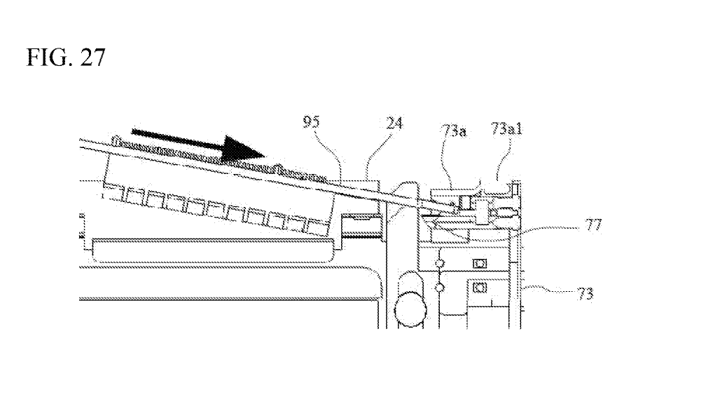

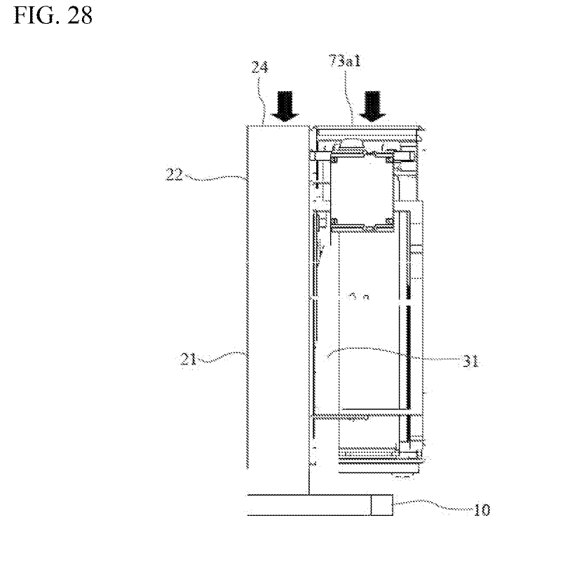

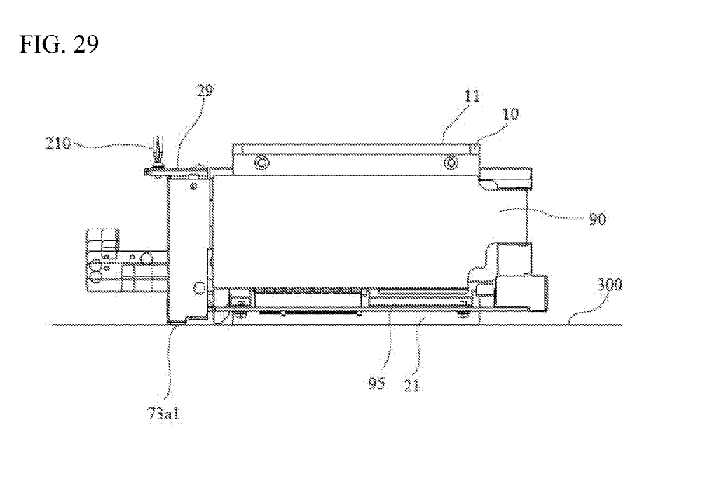

Next, the assembly work of the PC card cassette 60 using the assembly jig 1 is explained with reference to FIGS. 23A to 29. FIGS. 23A to 25N are explanation views illustrating a part of an assembly sequence of the PC card cassette 60. A series of the assembly sequence is illustrated by FIGS. 23A to 25N. FIG. 26 is an explanation view illustrating a state where the substrate 95 is made to slide on the guide portion 23b and is mounted on the cassette body 70. FIG. 27 is an explanation view illustrating a state where the front end portion of the substrate 95 is inserted in the lens storage unit 73. FIG. 28 is an explanation view illustrating a state where the substrate 95 is mounted on the cassette body 70. FIG. 29 is an explanation view illustrating a state where the third contact surface 24 is contacted with the work table 300.

Referring to FIG. 23A, first, the assembly jig 1 which has contacted the first contact surface 11 with the work table 300 is prepared. Then, as illustrated in FIGS. 23B-1 and 23B-2, the lower end portion 75 of the cassette body 70 is inserted in the holding groove 50, and the cassette body 70 is held in the holding groove 50. The worker pushes the cassette body 70 until the lower end portion 75 contacts the bottom portion 51. Thereby, the top face 73a1 of the lens storage unit 73 and the third contact surface 24 become a flush state.

Next, the substrate 95 is mounted on the cassette body 70, as illustrated in FIG. 23C. At this time, the assembly jig 1 is in a state where the first contact surface 11 has contacted the work table 300, and a position at which the substrate 95 is mounted is located at the upper side of the cassette body 70. Therefore, it is easy for the worker to perform the assembly work. In addition, since the base unit 10 includes the projection portion 12, the assembly jig 1 can maintain a stable standing state. When the substrate 95 is mounted on the cassette body 70, first, the substrate 95 is pressed against a side of the first wall unit 21, and an under surface of the substrate 95 is arranged along the guide portion 23b, as illustrated in FIG. 26. Then, while the substrate 95 is being slid, the front end portion of the substrate 95 is slid into the lens storage unit 73, as illustrated in FIG. 27. Thereby, the front end portion of the substrate 95 can be set to a given position without colliding with the top plate portion 73a and the lens 77. Also at this time, the worker can view the front end portion of the substrate 95.

After the substrate 95 is set to the given position, the worker mounts the substrate 95 on the cassette body 70 using the screw 100, as illustrated in FIG. 23D. At this time, the tool 210 is used above the substrate 95. That is, the worker can perform the work, viewing the substrate 95 from above. Since the base unit 10 includes the projection portion 12, the stable state of the assembly jig 1 is maintainable also at the time of screw-fastening work.

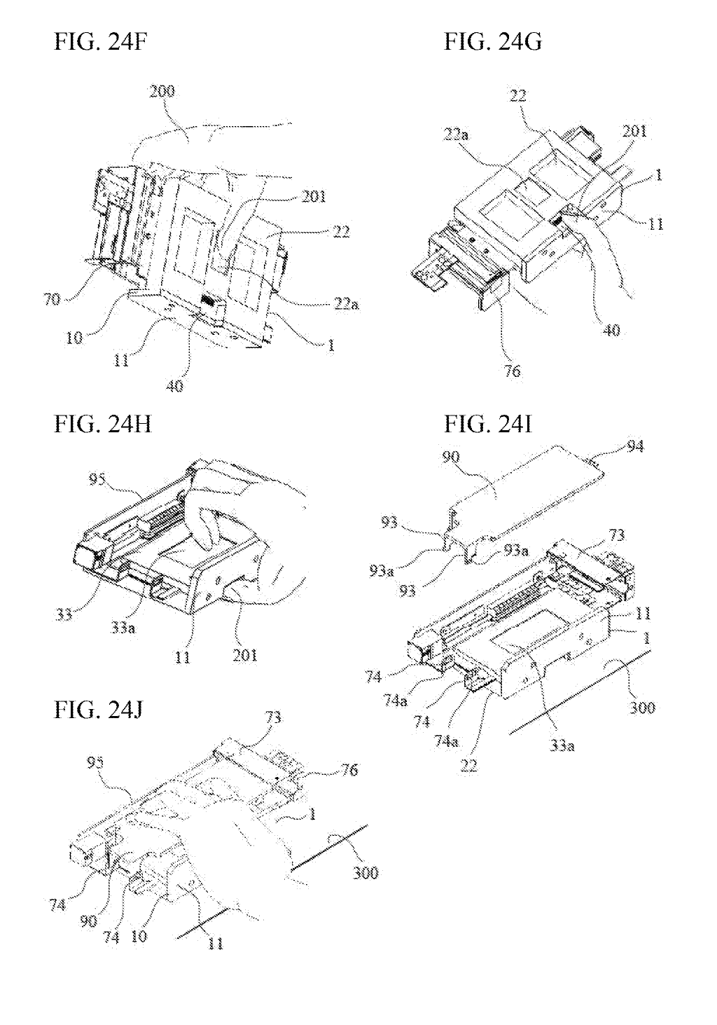

After the mounting of the substrate 95 is completed, the worker holds the assembly jig 1 by a hand 200 as illustrated in FIG. 23E, and lifts the assembly jig 1 as illustrated in FIG. 24F. At this time, the worker can hook fingers in the first concave portion 22a provided on the first wall unit 21 and the concave portion 33a provided on the second wall unit 31, and can lift the assembly jig 1. The first concave portion 22a and the concave portion 33a are useful as nonslip parts, and when the positions thereof are grasped. As a result, the first concave portion 22a and the concave portion 33a contribute to the quick work.

After the worker lifts the assembly jig 1, the worker changes the holding position of the assembly jig 1 so as to hook the thumb 201 in the finger hooking concave portion 40, as illustrated in FIG. 24G. Then, the worker turns a wrist so that the second contact surface 22 turns to the bottom, as illustrated in FIG. 24H. Then, the worker puts the assembly jig 1 on the work table 300 so that the second contact surface 22 contacts the work table 300.

Then, the side cover 90 is mounted on the cassette body 70, as illustrated in FIG. 24I. At this time, the side cover 90 can be mounted from above the cassette body 70. Therefore, the worker can perform the work while viewing the whole cassette body 70. Especially, when the side cover 90 is mounted on the cassette body 70, the hook-shaped portion 93a of each claw-shaped portions 93 has to be aligned with the engaging hole 74a, and the insertion portion 94 has to be inserted into the lens storage unit 73. Therefore, the work while viewing the whole cassette body 70 reduces the burden of the worker, and contributes to the quick work. Moreover, since the work becomes an operation pushed from above in order to push the hook-shaped portion 93a into the engaging hole 74a, the mounting work of the side cover 90 becomes easy.

After the mounting of the side cover 90 is completed, the worker pulls up the assembly jig 1, as illustrated in FIG. 24J. When the mounting of the side cover 90 is completed, the assembly jig 1 is in the state where the second contact surface 22 has contacted the work table 300. However, since the worker can insert the thumb 201 into the finger hooking concave portion 40, the worker can pull up the assembly jig 1 easily.

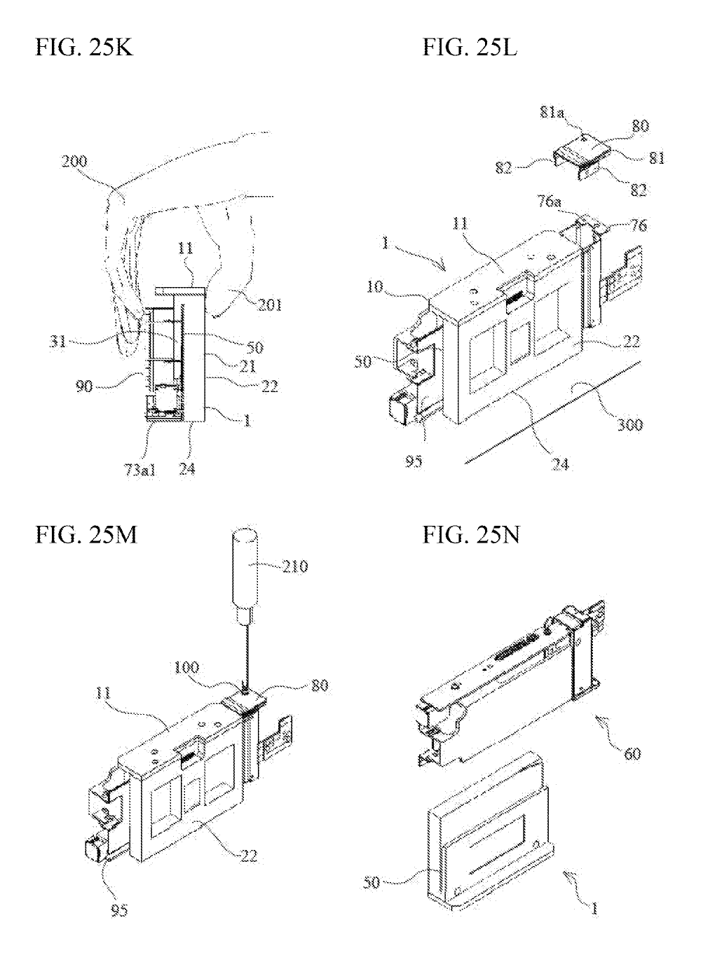

After pulling up the assembly jig 1, the worker turns the third contact surface 24 to the bottom, as illustrated in FIG. 25K. Here, since the third contact surface 24 and the top face 73a1 become the flush state as illustrated in FIG. 28, the top face 73a1 also contacts the work table 300 along with the third contact surface 24. Thereby, a contact area increases, and the work can be performed in the stable state.

After the assembly jig 1 is put on the work table 300 in a state where the third contact surface 24 and the top face 73a1 contact the work table 300, the bottom cover 80 is mounted on the mounting stay 76, as illustrated in FIG. 25L. The bottom cover 80 can also be mounted from above as the work. The bottom cover 80 inserts the insertion portions 82 between the cassette body 70 and the side cover 90, and arranges the bottom plate portion 81 on the mounting stay 76. Then, the bottom cover 80 is fixed on the mounting stay 76 using the screw 100, as illustrated in FIG. 25M. At this time, the tool 210 is used above the bottom cover 80. That is, the worker can perform the work, viewing the bottom cover 80 from above. At this time, since the substrate 95 does not contact the work table 300, as illustrated in FIG. 29, the substrate 95 is not damaged.

After the mounting of the bottom cover 80 is completed, the completed PC card cassette 60 is removed from the assembly jig 1, as illustrated in FIG. 25N. At this time, since the lower end portion 75 of the cassette body 70 is only sandwiched and held in the holding groove 50, the PC card cassette 60 can be easily extracted and removed from the assembly jig 1.

Here, the assembly of the PC card cassette 60 is completed. Basically, the worker can mount several kinds of parts on the cassette body 70 from above. That is, the work to the cassette body 70 from the plurality of directions included in the assembly work can be uniformly performed from above. As a result, since the worker is free from the work in an unreasonable attitude, working efficiency improves. Since the worker performs the work while viewing the parts of the PC card cassette 60 basically, the worker can avoid breakage of the parts as much as possible.

In the above-mentioned embodiment, it is assumed that the plurality of parts are mounted. However, for example, when the work from the plurality of directions is needed even if the work is the mounting of a single part, the assembly jig according to the present embodiment is effective.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An assembly jig, comprising:
a base unit;
a first wall unit that is stood on the base unit;
a second wall unit that is arranged in parallel with the first wall unit, and forms a member holding unit between the first wall unit and the second wall unit; and
at least two contact surfaces that contact a work table.

2. The assembly jig as claimed in claim 1, wherein
the base unit includes a first contact surface located on the opposite side of a surface on which the first wall unit is stood, and
the first wall unit includes a second contact surface located on the opposite side of a surface which is opposite to the second wall unit, and a third contact surface located on the opposite side of a surface at which the base unit is located.

3. The assembly jig as claimed in claim 2, further comprising:
a finger hooking concave portion that is formed on the first contact surface and the second contact surface adjacent to the first contact surface.

4. The assembly jig as claimed in claim 1, further comprising:
a guide unit that guides a part to be assembled to a member held in the member holding unit, to an assembly position of the member.

5. The assembly jig as claimed in claim 1, wherein
the second wall unit is mounted on the first wall unit with a fastening member.

6. The assembly jig as claimed in claim 1, wherein
a member holding unit is a holding groove formed between the first wall unit and the second wall unit, and a width of the holding groove becomes narrow toward a bottom portion.

7. The assembly jig as claimed in claim 1, wherein
a member holding unit is a holding groove formed between the first wall unit and the second wall unit, and includes a step portion that is provided near a bottom portion of the second wall unit 31 and protrudes to the inside of the holding groove.

8. The assembly jig as claimed in claim 1, wherein
the second wall unit includes a taper portion on an upper edge thereof.

9. The assembly jig as claimed in claim 1, wherein
each of the first wall unit and the second wall unit include a nonslip portion on an exterior wall surface.
